(19) United States
(12) Patent Application Publication
(10) Pub. No.: US 2009/0145468 A1
(43) Pub. Date: Jun. 11, 2009

(54) WASHING AND/OR RINSING DEVICE AND DISHWASHING MACHINE FEATURING SUCH A DEVICE

(75) Inventor: Alessio Chericoni, Terme (IT)

Correspondence Address: THOMPSON HINE LLP;Intellectual Property Group, P.O Box 8801, DAYTON, OH, 45401-8801, US

(73) Assignee: Premark FEG L.L.C., Wilmington, OH (US)

(21) Appl. No.: 12/329,117

(22) Filed: Dec. 5, 2008

(30) Foreign Application Priority Data
Dec. 5, 2007 (IT) TO2007A000881

(51) Int. Cl. B08B 3/02

(52) U.S. Cl. 134/168 R

(57) ABSTRACT

A washing and/or rinsing device for an electric household appliance, has an arm mounted in a rotating manner about and radially overhangingly from a generally vertical axis within a washing chamber, immediately either over or under a container basket for dishes, the arm delimiting a cavity therein, connected to dispensing means of a pressurized operative fluid and being provided with a plurality of nozzles arranged reciprocally spaced lengthwise along the arm and communicating with the internal cavity to eject in use corresponding pressurized jets of operative fluid; wherein at least first nozzles are arranged rotated with respect to a radial plane of the rotation axis passing through a longitudinal symmetry axis of the arm by angles progressively increasing with the distance of each first nozzle from the rotation axis and set so that, having fixed a direction of rotation in use of the arm about the rotation axis, the resultant of the absolute vectorial speed components of each jet generated by each first nozzle is noticeably parallel to the rotation axis.

### TECHNICAL FIELD

The present application relates to a rinsing and/or washing device for an electric household appliance, specifically for a dishwashing machine of the professional commercial type, capable of reducing the consumption of water and of ensuring more efficient washes.

### BACKGROUND

EP1050263 discloses a washing/rinsing device for dishwashing machines that includes a rotating arm (also named “lance” in technical language) provided with spraying nozzles and epicyclic movement in order to obtain an improved distribution of washing/rinsing fluid inside the washing chamber of the dishwashing machine, usually accessible through a front pivoting door.

However, in addition to being costly and complex, the known device has a large size, and in all cases does not solve the problem of reducing the amount of water (and, consequently of energy, the used water needing to be heated to relatively high temperature) required by the machine to perform the washing cycle in particular, nor above all, that of improving washing quality consistency, quality which may considerably vary today according to the type, and particularly to the size, of the dishes to be washed.

### SUMMARY

It would be desirable to provide an improved washing and/or rinsing device for an electric household appliance, specifically for a dishwashing machine for professional use, which overcomes one or more of the described drawbacks, thus allowing a reduction of water consumption (and therefore of energy consumption) of the dishwashing machine, allowing at the same time to improve the washing quality, and above all the washing quality consistency, upon the variation of the type of washed dishes, and in particular is independent of the size of the dishes and of the distance between the basket and the rotating arm carrying the nozzles themselves; this all by means of a device which is at the same time simple and cost-effective to be implemented and handled, with compact dimensions and high reliability.

A dishwashing machine provided with such a device has reduced energy and water consumption, along with a high washing quality.

A washing and/or rinsing device for an electric household appliance, in particular a dishwashing machine, is thus provided as claimed in the attached claims, as well as an electric household appliance, as claimed in the attached claims.

In particular, the device comprises at least one arm rotationally mounted about a generally vertical axis within a washing chamber of the electric household appliance, immediately either over or under a container basket of the dishes to be washed. The arm delimits a cavity therein, connected in use to dispensing means of a pressurized service fluid, e.g. washing and/or rinsing water, of the electric household appliance and is provided, on a first surface thereof oriented in use towards the dishes, with a plurality of spraying nozzles, reciprocally spaced lengthwise along the arm and communicating with the internal cavity of the latter, so as to determine in use the exiting of service fluid from the arm in the form of jets directed towards the dishes.

At least first nozzles are arranged rotated, with respect to a radial plane of the rotation axis passing through a longitudinal symmetry axis of the arm, by angles progressively increasing with the distance of each first nozzle from the rotation axis; the rotation angles are further chosen so that, having fixed a direction of rotation in use of the arm about the rotation axis, the resultant of the absolute vectorial speed components of each jet generated by a first nozzle is noticeably parallel to the rotation axis.

“Noticeably parallel to the rotation axis” hereinafter means substantially parallel to the rotation axis or inclined with respect to the same on a plane which is transversal to the arm by an angle of a few degrees (e.g. less than 10°) or however such that the absolute vectorial speed component directed in the rotating motion direction of the arm is not null, but is however lower than the peripheral speed of the arm at the considered jet.

In this manner, the water dispensed from the first nozzles, which are all the washing or rinsing nozzles of the arm, strikes in use the basket always in a direction substantially perpendicular to the same, regardless of the rotation speed of the arm and regardless of the distance of the latter from the basket, measured along the rotation axis. As further experimentally demonstrated, this implies that, independently of the size of the dishes present in the basket, these are struck by the water jets dispensed by the nozzles of the arm in an almost identical manner on both opposite sides of the dishes arranged transversally to the laying plane of the arm.

Therefore, on one hand, it is sufficient to dispense in use a smaller amount of water as compared to the known washing and/or rinsing devices, because practically no water is “wasted” as the water is directed so as to strike against the basket, instead of against the dishes and, on the other hand, an absolute washing quality consistency is obtained, regardless of the size of the dishes in the basket and of the distance of the basket from the arm, because all sides or faces of the dishes which are present are uniformly struck by substantially the same amount of water.

According to a first possible embodiment, the arm has a tubular shape with an annular cross section, and the first nozzles are integrally carried by the arm in different angular positions on the plane of the cross section of the arm.

According to another possible embodiment, instead, the arm has the first nozzles all arranged reciprocally aligned and parallel to the longitudinal axis of the arm in its cross section, the latter having been plastically deformed on the cross plane to the longitudinal axis of the arm due to a torsion applied about the longitudinal axis of the arm to a progressively increasing extent with the increase of the distance from the rotation axis and in such a direction to move a front longitudinal edge of the arm, orientated in use in a direction agreeing with that of rotation of the arm, away from the dishes.

The differentiated angular orientation of the nozzles is thus obtained in both cases in a simple manner, substantially without additional costs as compared to a traditional arm or lance, because it is achieved either by obtaining appropriately oriented seats for the nozzles on the arm, or by performing a simple plastic torsion operation of the arm, which may be easily carried out either automatically or manually, e.g. by means of appropriate templates.

Finally, the arm may be provided with at least one second nozzle arranged so as to generate a reaction thrust to determine in use the rotation of the arm about the rotation axis in a predetermined direction and at a predetermined speed. Alternatively, at least one of the first nozzles, preferably the one farthest from the rotation axis, is adapted to dispense in use a jet with the axis being skew with respect to the rotation axis by an angle such as to generate in use the above reaction thrust such as to determine the rotation of the arm without needing to use a dedicated nozzle for this purpose (which may be preferably used in washing devices where the washing water is circulated in a closed cycle, but its use is not very convenient in rinsing devices, which work in a prevalently open circuit, where this would produce an increase of water consumption).

### BRIEF DESCRIPTION OF THE DRAWINGS

Further objects and advantages will be apparent from the following description of a non-limitative embodiment thereof, only provided by way of example, with reference to the accompanying drawings, in which:

FIG. 1 diagrammatically shows a perspective view of a dishwashing machine provided with a washing and/or rinsing device;

FIG. 2 shows a diagrammatic perspective view of the device in FIG. 1 shown next to corresponding vectorial diagrams of the absolute and relative speeds of the jet dispensed by two different nozzles of a rotating arm belonging to the washing and/or rinsing device;

FIG. 3 diagrammatically shows a longitudinal, side, elevation view of a first embodiment of the device in FIG. 1, the washing and/or rinsing jets of water generated by the device in use being highlighted;

FIGS. 4 and 5 respectively show a plan top view and a cross elevation view of the device in FIG. 3; and

FIGS. 6 and 7 diagrammatically show a top plan view and a cross elevation view, respectively, of a second possible embodiment of the device.

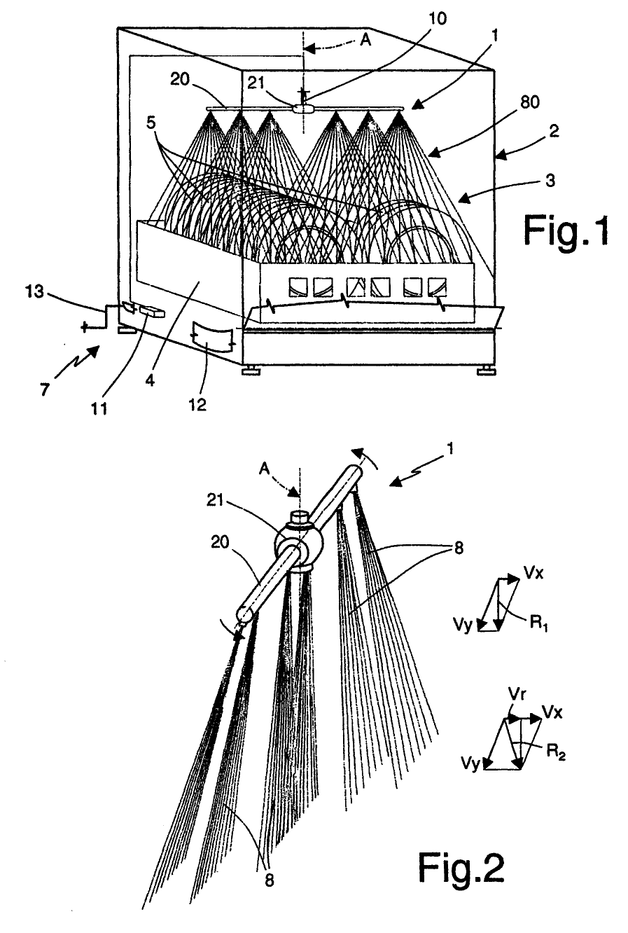

### DETAILED DESCRIPTION

In figures from 1 to 5, numeral 1 indicates as a whole a washing and/or rinsing device for an electric household appliance 2, in particular a dishwashing machine for professional use, of the front loading type in the example shown.

The dishwashing machine 2 specifically comprises a washing chamber 3 accommodating at least one container basket 4 (known) for the dishes 5 to be washed, the washing device 1 and dispensing means 7 of a pressurized service fluid 80, e.g. consisting either of washing water possibly with the addition of detergent, or of rinsing water, towards the device 1, in this case towards an outlet 10 arranged in the washing chamber 3 with the symmetry axis A thereof arranged substantially vertical and connected to the rinsing device 1 in the manner disclosed below.

The dispensing means 7 of the pressurized water are known and comprise in this case a pump 11, a tank 12 in which the water dispensed in use onto the dishes 5 through the outlet 10 and the device 1 is collected, and network-water feeding means 13, the pump 11 being able to use both the network-water (during the rinsing cycle) and the water in the tank 12 (during the washing cycle).

The device 1 comprises at least one arm 20 rotationally mounted about axis A, which is generally vertical, within the washing chamber 3 of the electric household appliance 2 immediately over (in the non-limiting example shown) or under the container basket 4, in this case idly and fluid-tightly mounted, in a known manner and therefore not described in detail for simplicity, to the outlet 10 by a central assembly portion 21 thereof.

The arm 20 delimits a internal cavity 22 therein (FIG. 4) connected in use to the water dispensing means 7 through the outlet 10 and is provided integral with a plurality of spraying nozzles 23,24,25 each adapted to generate a corresponding jet 8 of pressurized fluid 80 (e.g. at approximately 0.7 bar).

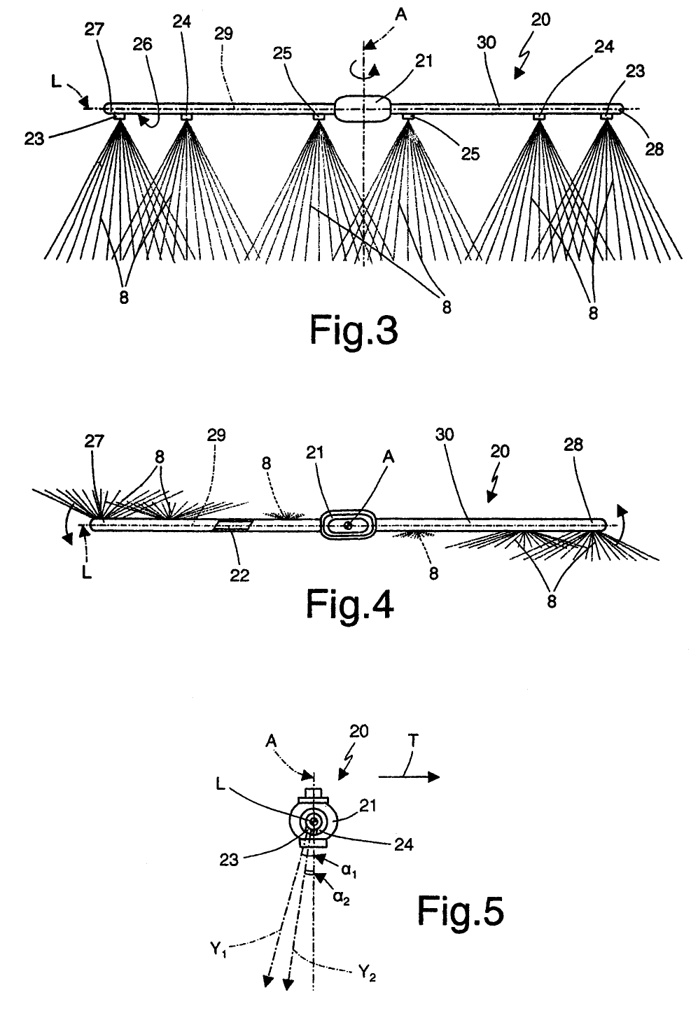

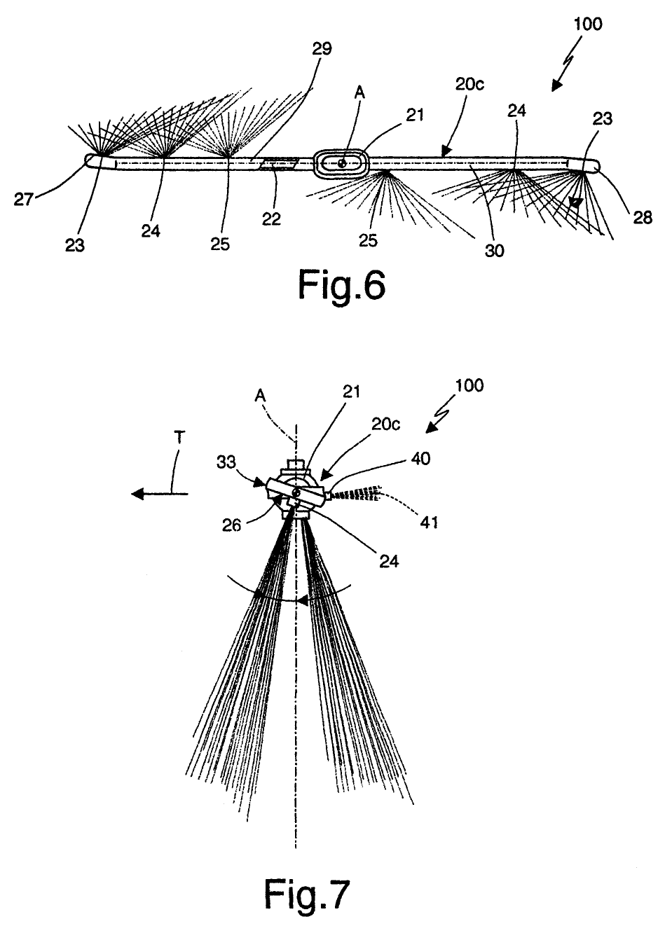

In particular, the nozzles 23,24,25 are obtained or located on a first surface 26 of the arm 20, in the shown embodiment the lower surface, which may be either flat, in the case of flat arms 20c, “biscuit”-shaped, or paddle-shaped (FIGS. 6 and 7), or curved, in the case of circular- or elliptical-section, tubular arms 20b (FIGS. 2-5). In all cases, the surface 26 is oriented in use towards the dishes 5 and the nozzles 23,24,25 may be carried by the same being arranged substantially coplanar or flushed with the surface 26 itself, and may be arranged reciprocally spaced lengthwise along the arm 20 and communicating with the internal cavity 22 of the latter.

Opposite ends 27,28 of the arm 20 extend radially and overhangingly, from opposite sides, from the rotation axis A, which is placed at the middle line of the arm 20, the latter having the assembly portion 21 for securing it to the rotation axis A substantially arranged indeed on the middle line of the arm 20 itself, so that opposite longitudinal portions 29,30 of the arm 20, delimited at the lower part thereof by the surface 26 and which are provided with nozzles 23,24,25, end with their opposite ends 27,28 and protrude in use so as to be substantially symmetric to the assembly portion 21 in the radial direction with respect to rotation axis A.

According to the major aspect of the invention, the nozzles 23,24,25 of each portion 29,30 are arranged rotated with respect to a radial plane of the rotation axis A passing through a longitudinal symmetry axis L of the arm 20 by angles α (e.g. α1, α2—FIG. 5) progressively increasing with the distance of each nozzle 23,24,25 from the rotation axis A; furthermore, the angles α are chosen so that, having fixed a rotation direction T in use of the arm 20 about the rotation axis A (shown in FIGS. 2 to 5 by the arrows), the resultant R of the absolute vectorial speed components Vx,Vy (FIG. 2) of each jet 8 generated by one of the nozzles 23,24,25 is noticeably parallel to the rotation axis A.

In particular, in FIG. 2, Vx indicates the absolute speed component of each jet 8 directed parallelly to the angular speed vector of the arm 20, while Vy indicates the absolute speed component of each jet 8 directed along the axis of the corresponding nozzle 23,24,25 (axes y1 and y2 in FIG. 5, relatively to nozzles 24—shown—and 25—not shown as covered by the nozzle 24) in the portion 29 of the arm 20b. R1 indicates the resultant for the jets dispensed by the nozzles 24,25, while R2 indicates the resultant for the jet dispensed by the nozzle 23, which is the radially farthest from the rotation axis A for both portions 29,30 of the arm 20b.

The rotation angle α with respect to the mentioned radial plane of the nozzles 23,24,25 carried by the longitudinal portion 29 of the arm 20 is opposite to those of the corresponding nozzles carried by the longitudinal portion 30 of the arm 20.

In the embodiment shown in FIGS. 2 to 5, the device 1 is provided with an arm 20b which has a tubular shape with an annular cross section, and the nozzles 23,24,25 are integrally carried by the arm in different angular positions on the plane of the cross section of the arm 20b itself, which coincides with the plane of the sheet in FIG. 5.

FIGS. 6 and 7 further show a variant of the device 1, in which the details similar or equivalent to those of the device 1 are shown for simplicity with the same reference numbers, wherein a washing and/or rinsing device 100 comprises an arm 20c which has the nozzles 23,24,25 all arranged reciprocally aligned and parallel to the longitudinal axis L of the arm 20c in its cross section, the latter having been plastically deformed on the cross plane to the longitudinal axis L of the arm due to a torsion applied about the longitudinal axis L of the arm 20c to a progressively increasing extent with the increase of the distance from the rotation axis A and in a direction such that a front longitudinal edge 33 (FIG. 7) of the arm 20c, orientated in use in a direction agreeing with that of rotation T of the arm 20c itself, is moved away from the dishes.

The arm 20c, typically a washing arm (while the arm 20b is typically a rinsing arm) has a generally flat shape, substantially a biscuit-shape, being delimited between two reciprocally parallel faces, substantially flat or slightly convex, one of which defines the lower surface 26 of the arm 20c carrying the nozzles 23,24,25 either coplanar or flushed.

According to a first possible alternative embodiment, the rotation angles α of all the nozzles 23,24,25, however obtained (either by means of a different angular positioning of the nozzles themselves or by means of a plastic torsion deformation of the arm 20), are chosen so that, having fixed the rotation direction T, in use, of the arm 20 about the rotation axis A, the resultant R of the absolute vectorial speed components Vx,Vy of each jet 8 is always substantially parallel to the rotation axis A and, consequently, substantially perpendicular, in use, to the basket 4; in this case, the arm 20 is further provided with at least one further nozzle 40 (FIG. 7) arranged so as to generate a reaction thrust for determining in use the rotation of the arm 20 (the washing arm 20c in the illustrated case) about the axis A in the predetermined or set direction T and at a predetermined or set angular speed (e.g. 60 rpm), for example because it dispenses a jet 41 of fluid 80 which is tangentially directed to the arm 20. Obviously, the nozzle 40 will preferably be positioned at one or both of the ends 27,28.

According to another possible alternative embodiment, the rotation angles α of the nozzles 23,24,25 are chosen so that, having fixed the rotation direction T in use of the arm 20 about the rotation axis A, the resultant R1 of the absolute vectorial speed components Vx,Vy of most of the jets 8 generated by the nozzles, in this case those dispensed by the nozzles 24 and 25, is substantially parallel to the rotation axis A in use and, consequently, substantially perpendicular to the basket 4; while the resultant R2 of the absolute vectorial speed components Vx,Vy of the jet 8 generated by at least one of the nozzles 23 arranged farthest from the rotation axis A, is skew with respect to the rotation axis A by an angle such that a reaction thrust to determine the rotation of the arm 20 (the arm 20b in this case) about the axis A in the predetermined or set direction T and at a predetermined or set speed is generated in use. In such a case, along the direction of the speed vector Vx a residual speed component Vr will remain (FIG. 2), not compensated by the direction of the speed vector Vy and thus not null, but however lower than the angular speed vector of the arm 20.

Therefore, the corresponding jet 8 will not strike the basket 4 perpendicularly to the same, but however at an angle of a few degrees, which is noticeably smaller than the incidence angle of the jets generated by the known washing and/or rinsing devices heretofore, thus determining a negligible “drawback” which is widely compensated by the fact that an appropriate reaction thrust jet for the rotation of the arm 20, such as the jet 41, does not need to be included.

According to a further, possible variant (FIG. 6), the same result could also be obtained by skewing the jet 8 of at least one of the nozzles 23 (or both) by means of a plastic deformation of the ends 27,29 of the arm 20 in a circumferential direction, instead of by means of a “reduced” rotation of the corresponding nozzle.

What is claimed is:

1. A washing and/or rinsing device for a dishwashing machine, comprising an arm mounted in a rotating manner about and radially overhangingly from a generally vertical axis within a washing chamber of the dishwashing machine, immediately either over or under a container basket for dishes the arm delimiting a cavity therein, connected to dispensing means of a pressurized operative fluid and being provided with a plurality of nozzles arranged reciprocally spaced lengthwise along the arm and communicating with the internal cavity to eject in use jets of operative fluid towards the dishes; characterized in that at least first nozzles are arranged rotated with respect to a radial plane of the rotation axis passing through a longitudinal symmetry axis of said arm by angles progressively increasing with the distance of each first nozzle from the rotation axis; said angles being set so that, having fixed a direction of rotation in use of the arm about the rotation axis, the resultant of the absolute vectorial speed components of each jet generated by each first nozzle is noticeably parallel to the rotation axis.

2. A device according to claim 1, characterized in that said first nozzles are carried by the arm on a first surface thereof oriented in use towards the dishes.

3. A device according to claim 1, characterized in that said rotation axis of the arm is positioned in the middle of the arm itself, the arm having a mounting portion for securing it to said rotation axis and essentially arranged in the middle of the arm itself, so that first and second opposite longitudinal portions of the arm, delimited at least in part by said first surface provided with said nozzles and ending with opposite free ends of the arm, protrude in use in an essentially symmetric manner from the mounting portion in a radial direction with respect to the rotation axis; the rotation angle with respect to said radial plane of the first nozzles carried by the first longitudinal portion of the arm being opposite to the rotation angle of the first nozzles carried by the second longitudinal portion of the arm.

4. A device according to claim 1, characterized in that said arm has a tubular shape with annular cross section, said first nozzles being integrally carried by the arm in different angular positions on the plane of said cross section of the arm.

5. A device according to claim 1, characterized in that said arm has said first nozzles all arranged reciprocally aligned and parallel to the longitudinal axis of the arm in its cross section, the latter having been plastically deformed on the cross plane to the longitudinal axis of the arm by effect of a torsion applied about the longitudinal axis of the arm to a progressively increasing extent to the increase of the distance from the rotation axis and in such a direction to move a front longitudinal edge of the arm orientated in use in a direction agreeing with that of rotation of the arm away from the basket.

6. A device according to claim 5, characterized in that said arm displays a generally flat shape, essentially biscuit-shaped, being delimited between two reciprocally parallel faces, essentially flat or slightly convex, one of which defines said first surface of the arm.

7. A device according to claim 6, characterized in that said rotation angles of said first nozzles are set so that, having fixed a direction of rotation in use of the arm about the rotation axis, the resultant of the absolute vectorial speed components of each jet generated by each first nozzle is essentially parallel to the rotation axis and, consequently, in use, essentially perpendicular to the basket; said arm being further provided with at least one second nozzle arranged so as to generate a reaction thrust to determine in use the rotation of the arm about said axis in the direction and at a predetermined speed.

8. A device according to claim 1, characterized in that said rotation angles of the first nozzles are set so that, having fixed a direction of rotation in use of the arm about the rotation axis, the resultant of the absolute vectorial speed components of most of the jets generated by the first nozzles is, in use, essentially parallel to the rotation axis and, consequently, essentially perpendicular to the basket; and that of the jet generated by at least one first nozzle farthest from the rotation axis (A), is skew with respect to the rotation axis by an angle such as to generate in use a reaction thrust such as to determine the rotation of the arm about said axis in the direction and at a predetermined speed.

9. A front-loading dishwashing machine including a device according to claim 1, comprising a washing chamber accommodating at least one container basket for dishes to be washed, and dispensing means of a pressurized service fluid towards an outlet arranged in the washing chamber with an essentially vertical symmetric axis thereof, characterized in that the dishwashing machine comprises the device according to claim 1, wherein the arm is idly and fluid-tightly mounted on said outlet with a central mounting portion thereof, immediately either over or under said basket.

10. A dishwashing machine, comprising:
a washing chamber, an arm mounted in a rotating manner about and radially overhangingly from a generally vertical axis within the washing chamber, immediately either over or under a dish receiving location of the washing chamber, the arm defining a cavity therein, connected to a source of cleaning liquid and being provided with a plurality of nozzles arranged lengthwise along the arm and communicating with the internal cavity to eject in use jets of cleaning liquid towards the dish receiving location; characterized in that at least first nozzles are arranged rotated with respect to a radial plane of the rotation axis passing through a longitudinal symmetry axis of said arm by angles progressively increasing with the distance of each first nozzle from the rotation axis; said angles being set so that a spray direction of each first nozzle is inclined away from a direction of rotation of the arm during cleaning liquid spraying.

11. A dishwashing machine according to claim 10, wherein said angles are set such that the resultant of the absolute vectorial speed components of each jet generated by each first nozzle is noticeably parallel to the rotation axis.
